(19) United States
(12) Patent Application Publication
(10) Pub. No.: US 2017/0144377 A1
(43) Pub. Date: May 25, 2017

(54) THREE-DIMENSIONAL PRINTER WITH INDEPENDENTLY MOVABLE PRINTER ROBOT

(71) Applicant: FITNII INC., TAIPEI CITY (TW)

(72) Inventor: MING-YING WU, TAIPEI CITY (TW)

(21) Appl. No.: 14/948,317

(22) Filed: Nov. 21, 2015

(51) Int. Cl. B29C 67/00; B33Y 50/02; B33Y 30/00

(52) U.S. Cl. CPC B29C 67/0088; B33Y 30/00; B33Y 50/02

(57) ABSTRACT

A three dimensional (3D) printer comprises at least one printer robot, and each of the at least one printer robot comprises a printer head used for printing out printing material to execute 3D printing commands, a locator being capable of sensing a position of the printer head, and a processor being data communicable with the printer head and the locator. The processor is used for receiving the 3D printing commands wirelessly, retrieving the sensed position of the printer head from the locator, and controlling the printer head to adjust the position of the printer head for printing out the printing material based on the received 3D printing commands. Each of the at least one printer robot further comprises at least three robot legs. The at least three robot legs are capable of situating on a working table for weight support of the at least one printer robot during 3D printing.

### BACKGROUND OF THE INVENTION

1. Field of the Invention

The present invention relates to a three-dimensional (3D) printer, particularly to a 3D printer and/or a 3D printing system having at least one printer robot capable of moving independently and moving free from controlling of other printer parts.

2. The Related Arts

Three-dimensional (3D) printing has become a popular business in recent years. Particularly, products of 3D printing can be used to immediately present stereoscopic designs sketched physically in a two-dimensional (2D) display using 3D simulated software. In other words, designers can make a quicker judgment regarding merits and demerits of their designs if they can actually see what has been designed on displays after the designed is immediately physically made by 3D printing. More applications regarding 3D printing are under rapid development and are gradually available to the public.

Usually, printers for 3D printing are made similarly to ordinary paper printers. Printer heads are secured in a large frame having printing controllers and printing material boxes, such as toners, disposed therein. It is easily understood, as the designed subjected for 3D printing becomes larger, the printers for 3D printing have to be made as big enough to print the designed. Hence, it is not possible for ordinary printers for 3D printing to print out something really large, such as a building model sized as a room. Hence, unless a really large frame of printers can be made, it always has a size limitation of printed-outs for the existing printers for 3D printing.

Besides, moving of printer heads of the existing printers for 3D printing is significantly limited as well. Secured in the frame of the existing printers for 3D printing, the printer head has to be able to move along three directions to precisely reach designed printing locations. Usually, layers of printed-outs are printed one by one on a working table along an upward direction vertical to the working table and away from the working table. It only has one chance to print a particular spot of the printed-out and one chance only. Hence, the printed-outs of the existing printers for 3D printing cannot be redone or modified in any way. Meanwhile, the printer head of the existing printers for 3D printing is usually fixed to supports inside the frame of the existing printers for 3D printing. In other words, a degree of freedom of the printer head is limited. Sometimes it is difficult to execute 3D printing when the printer head is required to print slantwise along a slant printing angle, such as an angle of 45° or 135° away from the gravity direction. For convenience design and manufacturing, the printer head of the existing printers for 3D printing is always set to print along the gravity direction only.

### BRIEF DESCRIPTION OF THE DRAWINGS

The present invention will become more readily apparent to those ordinarily skilled in the art after reviewing the following detailed description and accompanying drawings, in which:

FIG. 1 shows a schematic perspective view of a 3D printer in accordance with a preferred embodiment of the present invention.

FIG. 2 shows a schematic enlarged perspective view of a printer robot in accordance with a preferred embodiment of the present invention.

FIG. 3 shows a schematic side view of the printer robot of FIG. 2 starting printing in accordance with a preferred embodiment of the present invention.

FIG. 4 shows a schematic side view of the printer robot of FIG. 2 continuing printing by partially standing on printed-outs in accordance with a preferred embodiment of the present invention.

FIG. 5 shows a schematic side view of the printer robot of FIG. 2 continuing printing by mostly standing on the printed-outs in accordance with a preferred embodiment of the present invention.

FIG. 6 shows a schematic side view of the 3D printer of FIG. 1 when moving the printer robot of FIG. 2 toward a preset printing destination by a suspending system of the 3D printer in accordance with a preferred embodiment of the present invention.

FIG. 7 shows a schematic perspective view of the 3D printer of FIG. 1 using more than one printer robot for 3D printing in accordance with a preferred embodiment of the present invention.

### DETAILED DESCRIPTION OF PREFERRED EMBODIMENT

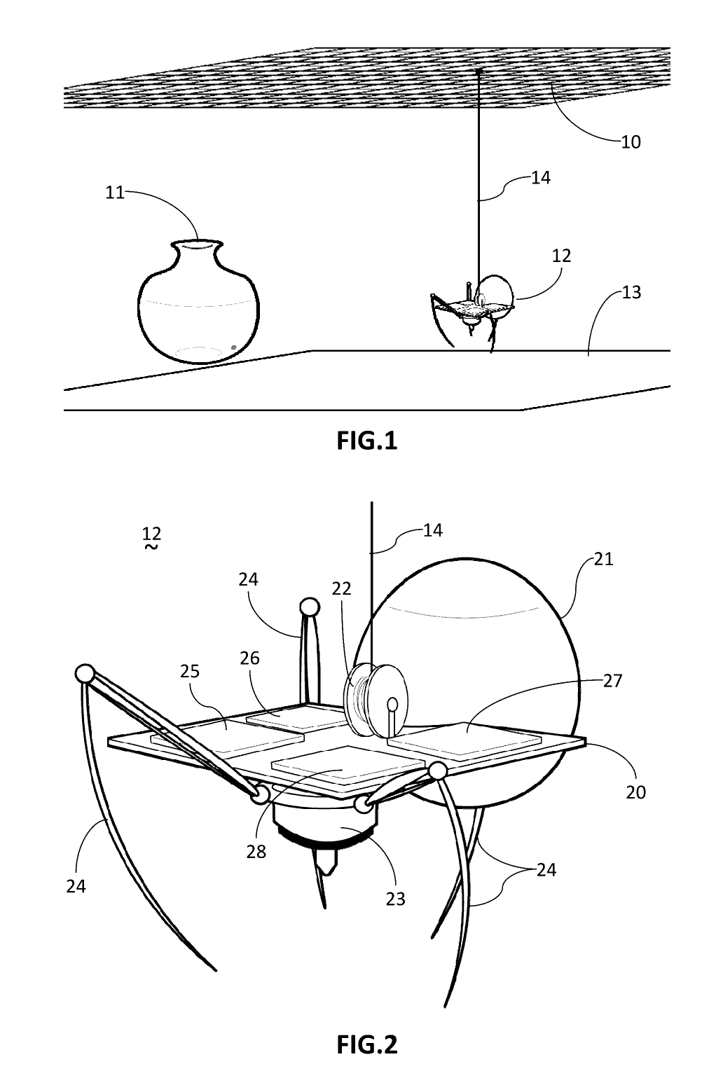

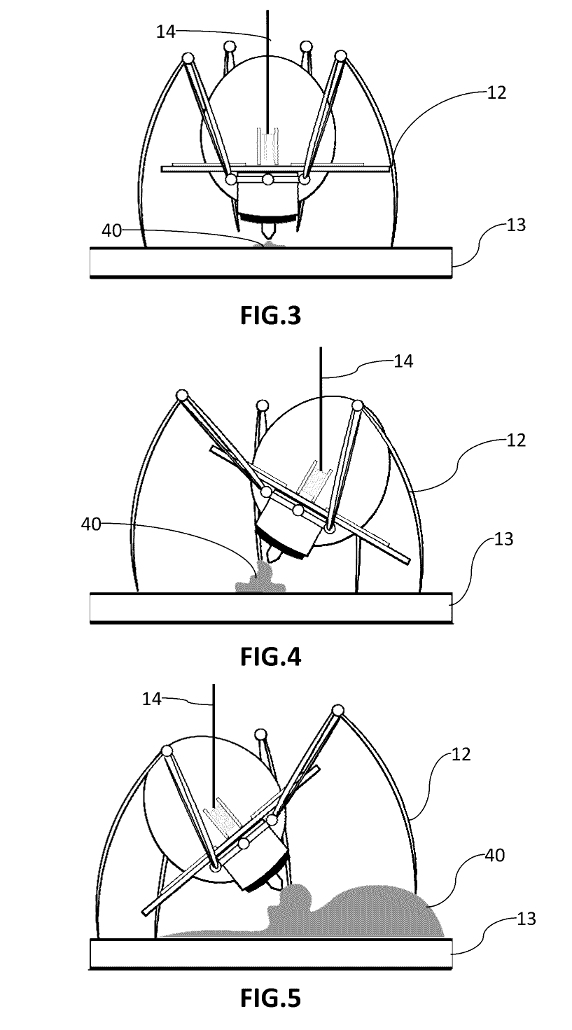

With reference to FIG. 1 and FIG. 3, a three-dimensional (3D) printer in accordance with an embodiment of the present invention comprises a suspending system 10, a material source 11 and at least one printer robot 12. A working table 13 is set to have a flat horizontal working surface facing upwards for support of printed-outs 40 of the 3D printer. The suspending system 10 is set to be located at an upper location vertically spaced away from the flat horizontal working surface of the working table 13. The material source 11 is set to be located at a side of the working table 13.

With reference to FIG. 1 and FIG. 2, each of the at least one printer robot 12 comprises a body 20, a material tank 21, a spool lifter 22, a printer head 23 and at least three robot legs 24. The body 20 is preferably a substrate or a circuit board. At least a processor 25, a memory 26, a locator 27 and a gyroscope 28 are disposed on the substrate of the body 20. A wireless module can be additionally disposed on the body 20 as well if the processor 25 is not integrated and equipped with wireless communication function. The processor 25 is data communicable with the memory 26, the locator 27 and the gyroscope 28, respectively. The memory 26 is used to save data required by the processor 25 for 3D printing. Printing commands for 3D printing are wirelessly transmitted to the processor 25 directly, or to the processor 25 indirectly via the wireless module. The received printing commands of the processor 25 are temporarily saved in the memory 26 for later execution of 3D printing. The locator 27 is used to position the printer head 23 for precisely 3D printing. The locator 27 is equipped with a global locating system (GPS), a location positioning system (LPS) or other positioning sensors such as an infrared sensor. The locator 27 is capable of sensing a current location of the printer head 23 and is data communicable with the processor 25 to decide whether or not the printer head 23 is located at a right position in accordance with the received printing commands. The gyroscope 28 is used to adjust a printing angle of the printer head 23. The gyroscope 28 is capable of sensing a horizontal degree of the printer head 23 and is data communicable with the processor 25 to decide whether or not the printer head 23 is adjusted to point along a right direction or point along a right printing angle. In another embodiment of the present invention, the locator 27 and the gyroscope 28 can be integrated in the processor 25 for cost down purpose.

The material tank 21 is disposed at a side of the body 20, and is used to store printing material therein. An exchanging mechanism is set at the material tank 21 to acquire additional printing material from the material source 11 when the at least one printer robot 12 approaches the material source 11 and the exchanging mechanism of the material tank 21 engages with the material source 11. The spool lifter 22 is disposed at an upper side of the body 20. A thread or a wire 14 made of either metal or plastics is disposed around the spool lifter 22 at one end thereof, and the other end of the thread or wire 14 extends and is connected with the suspending system 10. The spool lifter 22 and the suspending system 10 are data communicable with the processor 25, respectively. The spool lifter 22 is capable of lifting the at least one printer robot 12 with help of the suspending system 10 by spooling the thread or wire 14 in order to rapidly move the at least one printer robot 12 to a farther location of the working table 13. The printer head 23 is disposed at a lower side of the body 20. The printer head 23 is spatially communicable with the material tank 21 to acquire printing material from the material tank 21, and is capable of printing out the printing material from its distal end on the working table 13 by following the received printing commands.

The at least three robot legs 24 are disposed at sides of the body 20, and preferably have a number of four. Each of the at least three robot legs 24 is connected with the body 20 and is controlled by the processor 25 for its movement. Connecting locations of the at least three robot legs 24 with the body 20 are set to properly balance and position the entire at least one printer robot 12. Preferably, the at least three robot legs 24 are uniformly distributed around a periphery of the body 20 to be connected with the body 20. For instance, the preferable four robot legs 24 are connected with the body 20 with a 90-degree angle between extension directions of every two robot legs 24. Each of the at least three robot legs 24 is preferably composed of at least two moving sections and one joint to connect the at least two moving section together.

With reference to FIG. 3, FIG. 4 and FIG. 5, the 3D printer in accordance with the present invention starts to print out printing material on the working table 13 after the at least one printer robot 12 wirelessly receives a set of printing commands. The printing commands are wirelessly transmitted from a user inputting apparatus to the at least one printer robot 12 and temporarily saved in the memory 26 of the at least one printer robot 12. Referring to FIG. 3, at early stages of 3D printing in accordance with a preferred embodiment of the present invention, the processor 25 executes the temporarily saved printing commands in the memory 26 one by one and controls the printer head 23 to print printed-outs 40 on the working table 13 using the printing material stored in the material tank 21 by following the printing commands from users. As shown in FIG. 3, the printed-outs 40 on the working table 13 is sized smaller than the at least one printer robot 12, and the at least one printer robot 12 is steadily balanced and supported on the working table 13 for printing by four of the at least three robot legs 24. The processor 25 controls the four of the at least three robot legs 24 to move properly for precise 3D printing based on detection information and data respectively from the locator 27 and the gyroscope 28. The processor 25 is capable of adjusting printing positions and printing directions of the printer head 23 with help of the four of the at least three robot legs 24 in view of the detection information and data respectively from the locator 27 and the gyroscope 28 so that the printing commands from users can be precisely executed for 3D printing.

When the printed-outs 40 on the working table 13 gradually grows during 3D printing, the printed-outs 40 is very likely to be sized larger than the at least one printer robot 12. Referring to FIG. 4, in order to adjust the printing position and printing direction of the printer head 23 for better and much precise 3D printing, the at least one printer robot 12 is properly supported by using some of the four of the at least three robot legs 24 standing on the printed-outs 40 while others of the four of the at least three robot legs 24 stand on the working table 13. Since the at least one printer robot 12 is also partially supported and lifted by the suspending system 10 using the thread or wire 14 to connect with the spool lifter 22 of the at least one printer robot 12, and a distal end of each of the four of the at least three robot legs 24 is shaped as a needle, a weight of the at least one printer robot 12 will have less influence on the printed-outs 40 to cause any damage on appearance of the printed-outs 40. Similarly, referring to FIG. 5, in order to precisely execute the printing commands, the at least one printer robot 12 is required to work and situate mostly or entirely on the printed-outs 40. At this moment, the suspending system 10 is capable of being set to carry more of the weight of the at least one printer robot 12 in order to release damaging pressure of the printed-outs 40 from either ones of the four of the at least three robot legs 24 standing thereon.

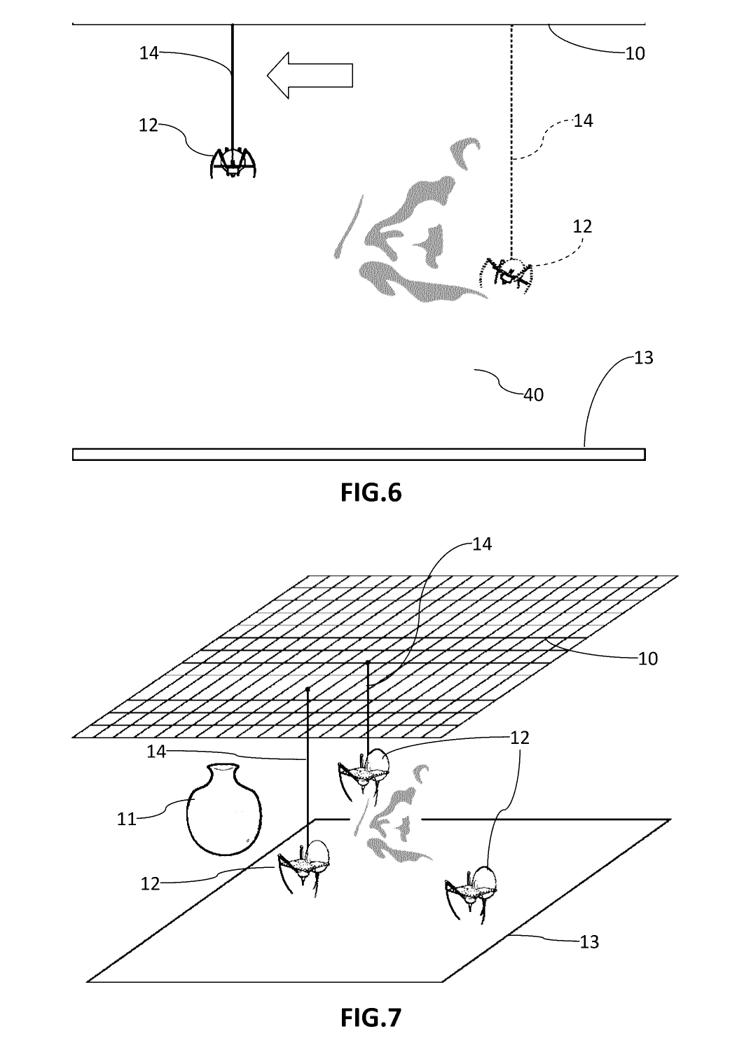

Further referring to FIG. 6, the at least one printer robot 12 is very likely to be required to move from a side of a large-sized printed-out 40 to another side of the printed-out 40 during 3D printing. The at least one printer robot 12 is able to be lifted directly by the suspending system 10 for moving from the side of the printed-out 40 to the another side of the printed-out 40. Instead of the at least one printer robot 12 moving by itself on the large-sized printed-out 40, less damage on the printed-out 40 will be caused during self moving of the at least one printer robot 12, and a lot of moving time can also be saved. Refill of the material tank 21 of the at least one printer robot 12 can also be achieved by the suspending system 10 to help moving the at least one printer robot 12 toward the material source 11.

Referring to FIG. 7, the at least one printer robot 12 is able to be set to have a number of more than one when executing the printing commands for the same large-scale printed-out 40. At this moment, each of the more than one printer robot 12 is set to receive a part of the printing commands for sub-tasks of a complete 3D printing task in order to work on an excluded area of the printed-out 40. The each of the more than one printer robot 12 is able to be freely and individually sent in or pulled out for 3D printing with help of the suspending system 10. 3D printing of the 3D printer in accordance with the present invention will not be interrupted by quitting of either one of the more than one printer robot 12 since the others of the more than one printer robot 12 are set to continuously work on the 3D printing.

Although only the preferred embodiments of the present invention are described as above, the practicing claim scope of the present invention is not limited to the disclosed embodiments. It is understood that any simple equivalent changes, adjustments or modifications to the present invention based on the following claims of the present invention and the content of the above invention description may be still covered within the claimed scope of the following claims of the present invention.

What is claimed is:

1. A three dimensional (3D) printer, comprising at least one printer robot, each of the at least one printer robot comprising:
a printer head used for printing out printing material to execute 3D printing commands;
a locator being capable of sensing a position of the printer head; and
a processor being data communicable with the printer head and the locator, the processor being used for receiving the 3D printing commands wirelessly, retrieving the sensed position of the printer head from the locator, and controlling the printer head to adjust the position of the printer head for printing out the printing material based on the received 3D printing commands.

2. The 3D printer as claimed in claim 1, wherein the each of the at least one printer robot further comprises a gyroscope, the gyroscope is data communicable with the processor, and is capable of sensing a horizontal degree of the printer head and providing the sensed horizontal degree of the printer head to the processor, the processor controls the printer head to adjust a printing angle of the printer head based on the sensed horizontal degree of the printer head and to be in accordance with the received 3D printing commands.

3. The 3D printer as claimed in claim 1, wherein the each of the at least one printer robot further comprises a body, the printer head, the processor and the locator are disposed at the body respectively.

4. The 3D printer as claimed in claim 1, wherein the each of the at least one printer robot further comprises at least three robot legs, the at least three robot legs are set to carry the at least one printer robot together for moving, and are set under control of the processor to balance and position the printer head for 3D printing.

5. The 3D printer as claimed in claim 4, wherein a distal end of each of the at least three robot legs is needle shaped to be situated on a working table or printed-outs formed from the printing material on the working table.

6. The 3D printer as claimed in claim 4, further comprising a suspending system, wherein the suspending system is spaced away from a working table, and is connected with the each of the at least one printer robot through a thread, the each of the at least one printer robot is supported by cooperation of the at least three robot legs standing on the working table or printed-outs formed from the printing material on the working table and the suspending system lifting the each of the at least one printer robot.

7. The 3D printer as claimed in claim 6, wherein the each of the at least one printer robot further comprises a spool lifter, the thread is disposed around the spool lifter and further connected with the suspending system.

8. The 3D printer as claimed in claim 1, wherein the each of the at least one printer robot further comprises a material tank, the material tank is used to store the printing material therein and is spatially communicable with the printer head to supply the stored printing material to the printer head.

9. The 3D printer as claimed in claim 8, further comprising a material source set beside a working table for 3D printing, and independent from the at least one printer robot without frame connection therebetween, wherein the material tank is material exchangeable with the material source to acquire additional printing material when the each of the at least one printer robot approaches the material source and the material tank engages with the material source.

10. A three dimensional (3D) printer, comprising at least two printer robots working on a working table respectively for 3D printing, each of the at least two printer robots comprising:
a printer head used for executing 3D printing; and
a processor being data communicable with the printer head, and being wirelessly received 3D printing commands for completing a 3D printing sub-task divided out of a 3D printing task;
wherein a sub-task completed by one of the at least two printer robots is different from a sub-task completed by another of the at least two printer robots, and the 3D printing task is completed by all of the at least two printer robots completing different sub-tasks, respectively.

11. The 3D printer as claimed in claim 10, wherein the each of the at least one printer robot further comprises a body, the processor and the printer head are disposed at the body respectively.

12. The 3D printer as claimed in claim 10, wherein the each of the at least one printer robot further comprises at least three robot legs, the at least three robot legs are set to carry the at least one printer robot for moving, and are set to balance and position the printer head for 3D printing.

13. The 3D printer as claimed in claim 10, wherein the each of the at least one printer robot further comprises a locator, the locator is used to sense a printing position of the printer head, and is data communicable with the processor to position the printer head together for precisely 3D printing.

14. The 3D printer as claimed in claim 10, wherein the each of the at least one printer robot further comprises a gyroscope, the gyroscope is data communicable with the processor, and is capable of sensing a horizontal degree of the printer head and providing the sensed horizontal degree of the printer head to the processor, the processor controls the printer head to adjust a printing angle of the printer head based on the sensed horizontal degree of the printer head and to be in accordance with the received 3D printing commands.

15. The 3D printer as claimed in claim 10, further comprising a suspending system, and the each of the at least one printer robot further comprising a spool lifter, wherein the suspending system is spaced away from the working table, and is connected with the spool lifter through a thread, the each of the at least one printer robot is capable of being lifted along a lifting direction by the suspending system and the spool lifter working together through the thread, and being moved by the suspending system along a direction perpendicular to the lifting direction.

16. A three dimensional (3D) printer, comprising:
a material source for providing printing material for 3D printing, and being set at a side of a working table; and
at least one printer robot working on the working table for 3D printing, each of the at least one printer robot comprising a processor, a printer head and at least three robot legs, the processor wirelessly receiving 3D printing commands, and executing the received printing commands to control 3D printing of the printer head, the at least three robot legs capable of situating on the working table for weight support of the each of the at least one printer robot during 3D printing of the each of the at least one printer robot.

17. The 3D printer as claimed in claim 16, further comprising a suspending system, and the each of the at least one printer robot further comprising a spool lifter, wherein the suspending system is spaced away from the working table, and is connected with the spool lifter through a thread, the each of the at least one printer robot is capable of being supported by cooperation of the at least three robot legs situating on the working table and the suspending system lifting the each of the at least one printer robot via the thread.

18. The 3D printer as claimed in claim 16, wherein the each of the at least one printer robot further comprises a locator, the locator is used to sense a printing position of the printer head, and is data communicable with the processor to position the printer head together for precisely 3D printing.

19. The 3D printer as claimed in claim 16, wherein the each of the at least one printer robot further comprises a gyroscope, the gyroscope is data communicable with the processor, and is capable of sensing a horizontal degree of the printer head and providing the sensed horizontal degree of the printer head to the processor, the processor controls the printer head to adjust a printing angle of the printer head based on the sensed horizontal degree of the printer head and to be in accordance with the received 3D printing commands.

20. The 3D printer as claimed in claim 16, wherein the each of the at least one printer robot further comprises a body, the processor and the printer head are disposed at the body respectively, the body and the material source are frameless therebetween, and the body is independent from the material source without any connection during moving of the each of the at least one printer robot.
